(19) United States
(12) Patent Application Publication
(10) Pub. No.: US 2025/0097492 A1
(43) Pub. Date: Mar. 20, 2025

(54) DYNAMIC ADAPTATION OF THE QUALITY FOR A MULTI-RESOLUTION TRANSMISSION OF CONTENT SEGMENTS

(71) Applicant: ORANGE, ISSY-LES-MOULINEAUX (FR)

(72) Inventors: Mathieu RIVOALEN, CHATILLON (FR); Hervé MARCHAND, CHATILLON (FR)

(21) Appl. No.: 18/887,520

(22) Filed: Sep. 17, 2024

(30) Foreign Application Priority Data
Sep. 18, 2023 (FR) 2309824

(51) Int. Cl. H04N 21/24; H04N 21/2662

(52) U.S. Cl. CPC H04N 21/2405; H04N 21/2662

(57) ABSTRACT

A method for delivering a stream of segments of a content from a server by at least one agent to a plurality of terminals. The method includes, at different moments during receipt of the content: verifying a load criterion of the agent, and, adapting, as a function of the verification, delivery of the content segments to the terminals.

### CROSS REFERENCE TO RELATED APPLICATION

This Application claims priority to and the benefit of French Patent Application No. FR 2309824, filed Sep. 18, 2023, the content of which is incorporated herein by reference in its entirety.

### FIELD OF THE INVENTION

The present invention relates to the field of transmission over a data stream telecommunications network, in particular including digital multimedia content, namely digital audio and/or video contents, also called audiovisual contents.

It more particularly relates to the management of the access, by a playback device, to segments of a content that are accessible from content servers. This content can be a multimedia content (video or audio-video for example) which can be in real time (called live content by those skilled in the art), or on demand (VoD for Video on Demand).

### BACKGROUND

Conventionally, a data stream, in particular a multimedia content data stream, is divided into segments.

These segments can be obtained according to different modalities. In particular, the segments can be obtained in a unicast mode, for example in the U-ABR (unicast adaptive bitrate) mode, or in a multicast mode, for example in the M-ABR (multicast adaptive bitrate) mode.

The U-ABR and M-ABR modes make it possible to download content segments using an adaptive progressive downloading technique (or adaptative streaming) by those skilled in the art.

The same content is transmitted in different resolutions to which each terminal can subscribe.

In a unicast obtaining (or transmission) mode, the segments are transmitted between an emitter (content server, etc.) and a recipient (a playback device, etc.). When several playback devices wish to obtain the same content, the segments are transmitted to each one independently, in as many segment streams.

The multicast obtaining (or transmission) mode aims to pool the transmission to several recipients. The recipients who wish to obtain the content request to subscribe to this multicast transmission service. A mechanism is then put in place to connect these new recipients to an existing delivery tree. This connection aims to optimize the pooling of the transmission by taking into account the network topology.

Thus, the closer we are to the content source, the more there is pooling, i.e. the same segment is only transmitted once for a set of distinct recipients. Thus a substantial gain in bandwidth is achieved.

In general, in an audio-visual delivery network, CDN (for Content Delivery Network), the streams of content segments are transmitted under this multicast transmission service.

In all cases, content segments at different resolutions are transmitted to an intermediate agent, which is as close as possible to the destination terminals and which is responsible for retransmitting the content segments to each terminal in the resolution that the latter requires and in unicast mode.

In such a scheme, it is understood that the intermediate agents must process the incoming segment streams in real time to deliver the appropriate packets to the terminals. Furthermore, the terminals connected to the same intermediate agent may require different contents.

However, the intermediate agents are generally embedded in personal gateways that do not have very significant resources, both in terms of processing capacities and memory capacities.

Also, as the number of terminals and/or the number of contents requested, and/or the number of resolutions per contents requested by the agents increases, the agent can become a bottleneck and penalize the overall performance of the content delivery network and the experience of the users of the terminals.

Such a situation is not acceptable for the users, and there is therefore a need to improve the current proposals of the state of the art.

### SUMMARY OF THE INVENTION

The invention aims to improve the general experience of the users of the terminals connected to a content delivery network by an intermediate agent. Particularly, it aims to avoid or at least minimize this contention phenomenon at the level of the intermediate agents.

For these purposes, according to a first aspect, the present invention can be implemented by a method for delivering a stream of segments of a content from a server by at least one agent to a plurality of terminals, the method comprising, at different moments during the receipt of said content:
a step of verifying a load criterion of said agent, and,
a step of adapting, as a function of said verification, the delivery of the content segments to the terminals.

According to preferred embodiments, the invention comprises one or several of the following characteristics which can be used separately or in partial combination with each other or in total combination with each other:
the content comes from a server in a multi-resolution transmission mode in response to a request specifying a maximum resolution, and wherein said adaptation comprises a determination of a new maximum resolution for transmission of a next request to said server.
the receipt of the content transmitted in multi-resolution mode with the new maximum resolution is followed by a modification of the delivery of the content segments to the terminals taking into account the new maximum resolution.
the adaptation comprises an establishment of a connection of at least one terminal of said plurality to said server in order to directly receive said content segments. It is thus also possible to thereby reduce the resource requirement at the agent level, by rerouting certain traffic.
the establishment of a connection comprises a transmission to said at least one terminal of a message adapted to trigger a request from said at least one terminal to said server in order to receive said content segments. The agent can thus maintain control and decide, on the fly, to redirect traffic, or on the contrary to reintegrate it according to the evolution of its own load.
the adaptation step is only triggered if a number of terminals among said plurality is smaller than a given threshold. It is thus possible to arbitrate the degradation of the maximum resolution associated with a content as a function of a number of terminals receiving this stream, and thus minimize the number of penalized users.
the load criterion comprises a comparison with a given threshold of a measurement of the activity of a processor of said agent and/or a measurement of filling of a memory of said agent. These criteria indeed make it possible to reveal the load state of an agent, involving the degradation of its performance, but other criteria can also be envisaged as an alternative or cumulatively.
the load criterion depends on a number of streams received by said agent and/or a number of resolutions and/or a number of terminals of said plurality.
the multi-resolution transmission mode is a multicast adaptive bitrate, m-ABR, transmission mode.
the agent is embedded in a gateway, for example a personal gateway such as Livebox™ from Orange. This avoids having an additional apparatus.

Another aspect of the invention relates to an agent for delivering a stream of segments of a content from a server to a plurality of terminals, said agent being adapted, at different moments during the receipt of the content, to:
verify a load criterion of said agent and,
depending on said verification, adapt the delivery of the content segments to the terminals.

Another aspect of the invention relates to a gateway including an agent as previously defined.

Another aspect of the invention relates to a computer program able to be implemented on a supervision device, the program comprising code instructions which, when executed by a processor, carries out the steps of the method as previously described.

Another aspect of the invention relates to a data medium on which at least one series of program code instructions has been stored for the execution of a method as previously described.

Other characteristics and advantages of the invention will become apparent upon reading the following description of one preferred embodiment of the invention, given by way of example and with reference to the appended drawings.

### BRIEF DESCRIPTION OF THE FIGURES

The appended drawings illustrate the invention:

FIG. 1 illustrates a telecommunications network allowing the implementation of a method according to embodiments of the invention;

FIG. 2 illustrates a flowchart of a possible method for delivering a stream of content segments by an agent to a plurality of terminals, according to one implementation of the invention.

FIGS. 3a and 3b illustrate one example of the course of the method, according to one implementation of the invention.

### DETAILED DESCRIPTION OF EMBODIMENTS OF THE INVENTION

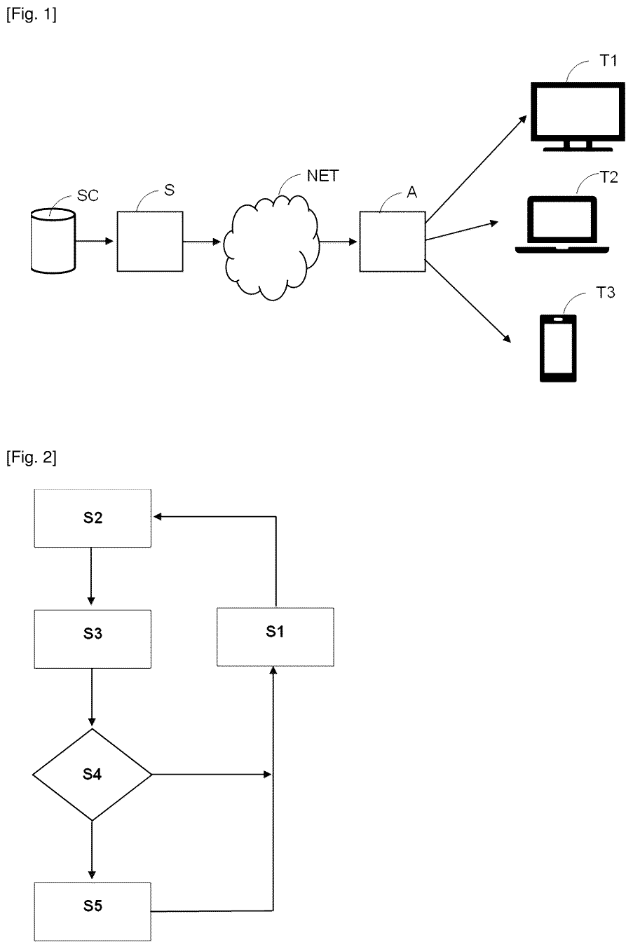

FIG. 1 illustrates a telecommunications network NET allowing the routing of data streams, formed of content segments, to a plurality of terminals or playback devices T1, T2, T3.

These terminals or playback devices can be of different types, such as in particular a mobile terminal, a connected television set, a computer, etc.

The mobile terminal can typically be a smart phone of the Smartphone type or a digital tablet, adapted to receive multimedia streams and to produce them on an interface of the terminal or connected to said terminal.

The television set can be connected natively or be connected by means of an associated device such as for example an HDMI stick connected to the television set

One example of an outer device communicating with a television set TV is Chromecast. The Chromecast is a real-time multimedia stream playback apparatus (multimedia gateway) developed and marketed by Google. The apparatus plugs into the HDMI port of a television set and communicates, via Wi-Fi connection, with another apparatus connected to the Internet (computer, Smartphone, tablet, etc.), in order to display on the television set the multimedia content received from an application compatible with Google Cast technology, from the Google Chrome browser present on a computer, or from some Android apparatuses.

In the latter case, the multimedia content playback device can be this associated device.

The data streams can be multimedia streams. These typically comprise video or audio-video streams (or contents). They can also be audio streams (music, radio broadcasts, etc.), or interactive contents (including games). They can be on-demand content or “live” content. This transmission mode can be an “IPTV” (Internet Protocol Television) type transmission mode, but other transmission modes can of course be envisaged.

Generally, the contents are divided into segments.

When an adaptive downloading mode of the ABR (Adaptive Bit Rate) type is implemented, the segments can be available in several resolutions. A file called “manifest” allows the playback devices, T, to choose a resolution based in particular on their local environment.

In unicast mode, these manifest files are transmitted by the unicast servers directly and the terminals negotiate directly with the server to choose the desired resolution.

In multicast mode (m-ABR), the manifest files are provided at the terminals by the agent A, and the terminals negotiate with this agent to choose the desired resolution. The corresponding segments are then transmitted to them in unicast mode, locally.

Thus the agent operates, from the agents' point of view, substantially like a content delivery network CDN server. Also, such an agent is sometimes called “nano CDN”.

The resolutions correspond to qualities of the video (and/or audio) content and consequently to different bitrates on the telecommunications network.

The qualities available in ABR can vary depending on the video streaming platform used, but in general and currently, the common qualities comprise:
Very Low Quality: often suitable for the users with very slow or unstable Internet connections, this quality can have a resolution of 240p and a bitrate of 200 kbps.
Low Quality: This quality is suitable for the more stable but still relatively slow Internet connections, with a resolution of 360p and a bitrate of 400-700 kbps.
Standard Quality: This quality is suitable for most Internet connections, with a resolution of 480p or 720p and a bitrate from 800 kbps to 2 Mbps.
High Quality: This quality is suitable for the fast and reliable Internet connections, with a resolution of 1,080p and a bitrate of 2-5 Mbps.
Very High Quality: This quality is suitable for the very fast Internet connections, with a resolution of 4K and a bitrate of more than 10 Mbps.

It is important to note that the available qualities may vary depending on the bandwidth capabilities of the user and of the network, as well as on the quality and on the complexity of the broadcast video content. The “manifest” file can then be modified according to the variations made at the level of the network or of the content server.

This content can be initially available on a source SC.

This source is connected to a content delivery network CDN by means of a server S, responsible in particular for shaping the segments for a multi-resolution transmission, ABR, and for possibly setting up a multicast transmission mode, for example m-ABR (multicast ABR).

The content delivery network forms, in a way, an overlay to the telecommunication network NET such as the Internet.

The content delivery network CDN can include one or several distinct content server(s). These servers can be unicast servers or multicast servers. In FIG. 1, a single server S is represented, but it should be understood that the method and the agent described below can take into account a multiplicity of servers.

Typically, the segments of the source SC are transmitted to a first unicast server, and to a second multicast server. The multicast server, or “multicaster”, can receive the segments from the unicast server when a decision is made to make the multicast transmission possible. This decision can for example be made by the first content server or by a supervision device having knowledge of the number of playback devices wishing to receive a given content.

The content delivery network CDN also includes intermediate equipment, or “agents”. These agents A can form a gateway between the public network on which the content delivery network CDN is deployed and a private network to which different content playback devices, T1, T2, T3, are connected.

This local area network can be a network installed at a user's home (home network) allowing him to connect different equipment, or content playback devices, to each other and to the gateway to the public network. Such a local area network can comply with different technologies, for example Wi-Fi, Ethernet™, Bluetooth, etc., or with a combination of a plurality of such networks.

According to one embodiment, the agent A is embedded in a gateway belonging to the home network and to the public network. This gateway can also provide additional functionalities such as that of a Wi-Fi router, etc.

One example of such a gateway is the Livebox™ from Orange.

FIG. 2 illustrates a flowchart of a possible method for delivering a stream of content segments by an agent A to a plurality of terminals, T1, T2, T3.

This process is iterative because the agent transmits series of requests in order to receive the content segments in response.

According to the proposed method, at each iteration, it is verified whether a condition on a load criterion is verified in order to decide on a possible adaptation of the requested resolutions at the following iteration.

The illustrated method relates to a single server, for the simplicity of the explanation, but it is clear that this same method applies, mutatis mutandis, to a plurality of servers S.

In a step S1, the agent A transmits a request to a content server S specifying a maximum resolution.

This maximum resolution is determined from the resolutions proposed by the server S through a manifest file describing the available resolutions.

These resolutions available from the server S can be proposed by the agent A to the terminals T1, T2, T3 which are connected to it (within a local area network) through a manifest file. The terminals can then choose a resolution according to their own environment (for example the quality of the connection to the agent A, the resolution of their screen, their processing capacity, the user's choices, etc.)

The maximum resolution required by the agent from the server S can also be determined according to the choices of the different terminals. It can correspond for example to the maximum resolution chosen by the terminals (for this same content).

In response to this request S1, the server S transmits, in a step S2, the content segment(s) to the agent A. According to one embodiment, this/these segment(s) correspond(s) to a multi-resolution transmission corresponding to the maximum resolution required.

In a step S3, the agent A delivers the received content segments to the terminals T1, T2, T3 in the resolution chosen by each of them.

The transmission of the segments is the result of the receipt of segment requests transmitted by the terminals to the agent A.

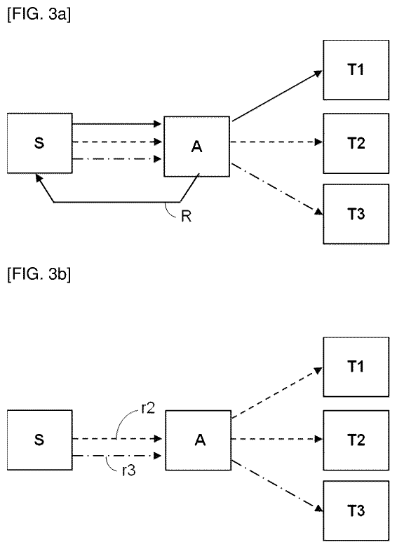

FIG. 3a illustrates one exemplary implementation with three terminals, T1, T2, T3, each having chosen a different resolution, respectively r1, r2, r3. In the illustrated example, it is assumed that these resolutions are ordered by order of quality r1>r2>r3.

The segments are transmitted in the 3 possible resolutions r1, r2, r3 from the server to the agent. The agent A conventionally processes the received segments to deliver them to the terminals T1, T2, T3.

At different moments during the receipt of the content, in a step S4, the agent verifies a load criterion. These moments can correspond to receipts, S2, of a response to requests S1. Particularly, these moments can be each receipt S2, but other embodiments can be envisaged (time period, etc.).

According to one embodiment, this load criterion can comprise a comparison with a given threshold of an activity measurement of a processor of the agent A, and/or of a measurement of filling of a memory of said agent. This memory can be a RAM memory or a Flash memory of the agent A. Of course, the load criterion can comprise comparisons of still other measurements.

The load of the agent can be related to a large processed volume of data.

The volume of these data is related to:
the number of received data streams,
the number of resolutions for each data stream,
the maximum resolution for each data stream (because the more qualitative a resolution, the bigger the associated data and the more they require processing resources),
the number of terminals connected to the agent to receive segments.

According to one embodiment, it can be considered that the agent A is loaded when at least one of the measurements made exceeds an associated threshold. According to another embodiment, an overall comparison can be made based on a sum, possibly weighted, of the different measurements and of its comparison with a single threshold.

The different thresholds can be determined beforehand.

According to one embodiment, the load criterion may depend on a number of streams received by the agent A, and/or a number of resolutions and/or a number of terminals connected to the agent A.

Depending on the result of the step of verifying the load criterion, a step S5 of adapting the delivery of the content segments to the terminals may or may not be set up.

This step S4 can comprise determining a change in the load of the agent, and in particular detecting the transitions from a normal state to a loaded state as well as from a loaded state to a normal state.

Transitions between different load levels can also be considered. Adaptation rules can then be associated according to the load levels.

If the load state is constant, i.e. if the result of the load criterion verification is the same as in the previous iteration (when requesting the previous content segments), then there is no need for adaptation, and the method loops back to step S1 of transmitting to the server S a request in new segments. This request specifies the same maximum resolution as the main request (except possibly if one of the connected terminals chooses a change of resolution).

If the load state is not constant, i.e. if we move from an iteration where the load criterion is met to an iteration where the load criterion is no longer met, or vice versa, then an adaptation step S5 can be triggered.

A step of adapting S5 the delivery of the content segments to the terminals is then implemented based on the verification of the previous step S4.

According to one embodiment, this adaptation step S5 comprises a modification of the delivery of the content segments to the terminals.

The modification of the delivery can be implemented in different ways.

This modification of the delivery can comprise the determination of a new maximum resolution for the transmission of a following request to said server.

In the case of a degradation of the load, the adaptation aims to reduce the need for resources on the agent by lowering the maximum resolution required at the server S.

According to one embodiment, the maximum resolution is lowered by one level.

The maximum resolution being the most impactful in terms of resources used, its lowering makes it possible to substantially reduce the load of the agent while maintaining an acceptable quality for the greatest number of connected terminals.

When the agent A manages several streams of segments of different content, the maximum resolution may be lowered only for some streams of segments solely.

For example, the adaptation step S5 is triggered only if a number of terminals among said plurality is smaller than a given threshold. In which case, an adaptation can be triggered for other streams of content segments passing through the same agent.

It can thus be chosen to arbitrate the degradation of the maximum resolution associated with a content, depending on a number of terminals receiving this stream. It can thus be chosen to lower the maximum resolution of the content streams corresponding to the smallest number of terminals that have subscribed to it. Thus, with substantially equal gain in processing resources, a smaller number of users is penalized.

Thus, if several terminals receive a first content chain and only one terminal receives another content chain, it will be preferred to degrade the quality for this other terminal, or to force its direct connection to the server corresponding to this other chain. This thus optimizes the management of the resources of the agent for the greatest number of terminals.

Moreover, concurrent tasks can also be deployed on the agent, so that its load can evolve over time independently of the loads induced by the content segment streams alone. Also, the proposed adaptation step S5 can be triggered even when the terminals do not modify the desired qualities in the requests (the verification step S4 being implemented for any request in content segment.)

Moreover, the adaptation of the delivery of the content segments to the terminals can also comprise the establishment of a connection from at least one terminal of the plurality to the server S in order to directly receive the content segments. In other words, the content segment stream then does not pass via the agent, which makes it possible to lower its load.

The establishment of a connection can comprise a transmission to this at least one terminal of a message adapted to trigger a request from the latter to the server S in order to receive the content segments.

In the case of an improvement (i.e. decrease) of the load, the adaptation aims to increase the quality for the users of the terminals by increasing the maximum resolution required at the server S. In general, this involves returning to a situation prior to a previous degradation.

This adaptation step therefore comprises the determination of a new maximum resolution. This new maximum resolution is then transmitted to the server S at step S1 of the following iteration.

In general, in the initialization phase, the terminals will require increasing qualities over time, until reaching a target quality or the limits of the network (or of the agent or of the server). The proposed method applies to this mechanism by allowing dynamic adaptation at each step of increase of the power of the terminals: access to a higher quality is thus subject to the proposed adaptation mechanisms S5.

In the example of FIG. 3b, related to the example of FIG. 3a, it is assumed that a load of the agent A is too high (the load criterion is met). The adaptation step S5 is therefore triggered. A new maximum resolution is therefore decided.

In the example of FIGS. 3a, 3b, the maximum resolution is lowered by one level: among the resolutions r1, r2, r3, the maximum resolution of better quality r1 is therefore deleted. Following the detection of the load state, the request R in new segments therefore specifies the resolution r2 as the maximum resolution.

At the iteration of FIG. 3b, the server S therefore transmits segments at the resolutions r2 and r3.

The terminal T2 was already receiving the stream of content segments in the resolution r2 and there is therefore no change for it. The same applies to the terminal T3 which was already receiving the content in the resolution r3.

On the other hand, the terminal T1 was previously receiving the stream of segments in the resolution r1. Since this resolution r1 is no longer available, it must adapt by choosing (for example) the maximum resolution available, r2.

Subsequently, if the load state of the agent A improves, it may require the resolution r1 again from the server S and make this resolution r1 available to the terminals T1, T2, T3. The terminal T1 may then choose to subscribe to this resolution again.

As mentioned above, “making available” a resolution may consist in publishing a manifest file accessible to the terminals and specifying the different resolutions available.

According to one embodiment, the adaptation step S5 also comprises the transmission to at least one terminal of a message adapted to trigger a request from this terminal to the server S in order to receive the content segments.

In other words, the agent forces the disconnection of one or several terminal(s) by redirecting it directly to the server. Thus, the agent A no longer has to manage the steps of receiving and delivering the segments for this/these terminal(s), which relieves its own resources.

However, this redirection can be done for each iteration, so that the agent always has control and can, when the step S4 of verifying the load criterion shows an improvement in the load state of the agent, reconnect the terminal(s) in question. Again, the agent will play the role of intermediary and of nano-CDN server: it will receive the segments from the server S and deliver them to the terminals in the required resolution.

This mechanism can be an alternative, for the terminal, to the degradation of the resolution of the content. Following the determination of a lower maximum resolution, the terminal(s) associated with it can be redirected directly to the server S.

In the example of FIG. 3b, the terminal T1 can thus download the content segments in resolution r1 directly from the server S.

According to one embodiment, this mechanism makes it possible to avoid degrading the maximum resolution and therefore provides an alternative to the adaptation step based on the determination of a new maximum resolution.

For example, if several terminals receive the same content in the maximum resolution, but a single terminal (or a smaller number) receives another content, even in a lower resolution, it can be chosen to lower this resolution, and to redirect it to the server S, in order to relieve the agent A.

Of course, the present invention is not limited to the examples and to the embodiment described and represented, but is defined by the claims. It is in particular subject to numerous variants accessible to those skilled in the art.

1. A method for delivering a stream of segments of a content from a server by at least one agent to a plurality of terminals, the method comprising:
at different moments during receipt of said content:
verifying a load criterion of said agent; and
adapting, as a function of said verification, delivery of the content segments to the terminals.

2. The method according to claim 1, wherein the content comes from a server in a multi-resolution transmission mode in response to a request specifying a maximum resolution, and wherein said adapting comprises determining a new maximum resolution for transmission of a next request to said server.

3. The method according to claim 2, wherein the receipt of the content transmitted in multi-resolution mode with the new maximum resolution is followed by a modification of the delivery of the content segments to the terminals taking into account the new maximum resolution.

4. The method according to claim 1, wherein the adapting comprises establishing a connection of at least one terminal of said plurality to said server in order to directly receive said content segments.

5. The method according to claim 4, wherein said establishing a connection comprises transmitting to said at least one terminal a message adapted to trigger a request from said at least one terminal to said server in order to receive said content segments.

6. The method according to claim 1, wherein said adapting is triggered only if a number of terminals among said plurality is smaller than a given threshold.

7. The method according to claim 1, wherein said load criterion comprises a comparison with a given threshold of a measurement of activity of a processor of said agent and/or a measurement of filling of a memory of said agent.

8. The method according to claim 1, wherein said load criterion depends on a number of streams received by said agent and/or a number of resolutions and/or a number of terminals of said plurality.

9. The method according to claim 1, wherein said multi-resolution transmission mode is a multicast adaptive bitrate, multicast adaptive bitrate (m-ABR), transmission mode.

10. The method according to claim 1, wherein said agent is embedded in a gateway.

11. An agent device for delivering a stream of segments of a content from a server to a plurality of terminals, said agent device comprising:
at least one processor configured to, at different moments during receipt of the content:
verify a load criterion of said agent; and
depending on said verification, adapt delivery of the content segments to the terminals.

12. A gateway including an agent device according to claim 11.

13. A non-transitory data medium readable by a computer on which at least one series of program code instructions has been stored, which when executed by at least one processor of an agent, configure the agent to implement a method for delivering a stream of segments of a content from a server to a plurality of terminals, the method comprising:
at different moments during receipt of said content:
verifying a load criterion of said agent; and
adapting, as a function of said verification, delivery of the content segments to the terminals.
